(19) United States
(12) Patent Application Publication
(10) Pub. No.: US 2015/0193087 A1
(43) Pub. Date: Jul. 9, 2015

(54) LIGHT VIBRATION TOUCH APPARATUS

(71) Applicant: Era Optoelectronics Inc., New Taipei City (TW)

(72) Inventor: CHIH-HSIUNG LIN, New Taipei City (TW)

(21) Appl. No.: 14/580,828

(22) Filed: Dec. 23, 2014

(30) Foreign Application Priority Data
Jan. 9, 2014 (TW) 103100878

(51) Int. Cl. G06F 3/042

(52) U.S. Cl. CPC G06F 3/0423

(57) ABSTRACT

A light vibration touch apparatus comprises a guide light plate, at least a light sensitive unit, at least an optical signal emitting unit, a microprocessor, and an optical signal processor; the optical signal emitting unit emits light signal to propagate in the guide light plate; the stability of the signal influenced with vibration caused by the guide light plate being touched is utilized; the optical signal processor outputs vibration signals corresponding to a touch point; the microprocessor detects the vibration signals sequentially output by the optical signal processor in a period to obtain position information of the touch point in accordance with timings of at least two of the vibration signals appearing in the period and output a corresponding touch signal.

### CROSS-REFERENCE TO RELATED APPLICATIONS

The application claims priority from Taiwan Patent Application No. 103100878 filed on Jan. 9, 2014, the disclosure of which is incorporated herein by reference.

### BACKGROUND OF THE INVENTION

1. Field of the Invention

The present invention relates to a touch device, and, more particularly, to a touch apparatus which detects positions of lights carrying signals being touched at the time of propagating therein to generate corresponding control signals.

2. Description of Related Art

There are many touch devices in association with guide light plates; for instance, U.S. Pat. No. 7,432,893 discloses an input device based on frustrated total internal reflection in which lights emitting from at least two light sources at two different positions are guided into a guide light plate to conduct total internal reflective propagation, wherein the light emitted from each light source is distributed in the entire light plate uniformly, and a light sensing array is disposed at peripheral sides of the guide light plate to detect the lights generated by the light sources. When an object contacts the surface of the guide light plate, the total internal reflection of the lights in the guide light plate are frustrated to attenuate the lights passing through the contact area; a processor is utilized to determine position of the object with triangulation according to the attenuation signals issued by the at least two light sources at different locations.

U.S. Patent application publication Numbers US2011074735, US20130044073, US20120162144, US20120268403, and US20130021300 disclose touch techniques related to the guide light plate.

The preceding touch techniques related to the guide light plate require lights issued by at least two light sources at different locations being guided into the guide light plate to perform the total internal reflective propagation and utilize a processor to determine position of the object according to at least two light sensors arrays detecting the attenuation signals issued by the at least two light sources at different locations and generate a corresponding touch signal. However, if the lights are projected into the guide light plate along unspecific incident angles, the total internal refection is incapable of being performed in the guide light plate. It is very difficult to adjust a light incident angle precisely, and it is required to provide guide light components which increase thickness or area of the touch device. In addition, if the touch point has a very small area, such as the tip of a toothpick, it is incapable of frustrating the total internal reflection in the guide light plate to obtain the corresponding touch signal.

### SUMMARY OF THE INVENTION

In order to improve the conventional guide light plate touch apparatus, the present invention is proposed.

The main object of the present invention is to provide a light vibration apparatus with which optical signal emitting units project optical signals propagating in a guide light plate, vibration resulting from the guide light plate being touched influences stabilities of the optical signals, an optical signal processor outputs vibration signals corresponding to the touch point, and a microprocessor detects the vibration signals output by the optical signal processing unit sequentially in a period, obtains position information of the touch point according to timings of at least two of the vibration signals appearing in the period and outputs a corresponding touch signal. Due to the light emitted by the respective optical signal emitting unit being projected into the guide light plate with an unspecific incident angle to conduct the total internal reflection, there is no need to adjust the troublesome incident angle difficultly.

Another object of the present invention is to provide a light vibration touch apparatus with which the generated vibration is capable of influencing the stabilities of the optical signals even if the area of the touch point on the guide light plate is very small such that the position information of the touch point can be obtained to promote the practical function of the touch apparatus without frustrating the total internal reflection of the respective light in the guide light plate.

The guide light vibration touch apparatus according to the present invention comprises: a guide light plate, a microprocessor, at least an optical signal emitting unit electrically connecting with the microprocessor, at least a light sensitive unit sensing the light emitted by the optical signal emitting unit, and an optical signal processor electrically connecting with the microprocessor and the light sensitive unit to detect and process a signal output by the light sensitive unit to obtain a vibration signal and transmit the vibration signal to the microprocessor; wherein the light emitted by the optical signal emitting unit carries a signal; vibration caused by the guide light plate being touched influencing stability of the signal is utilized; the optical signal processor outputs vibration signals corresponding to a touch point; the microprocessor detects the vibration signals sequentially output by the optical signal processor in a period to obtain position information related to the touch point in accordance with timings of at least two of the vibration signals respectively appearing in the period and output a corresponding touch signal.

The guide light plate of the light vibration touch apparatus according to the present invention has an upper surface, a lower surface and a peripheral surface; the peripheral surface is formed by lateral edges of the guide light plate; the respective optical signal emitting unit contacts or is disposed near the peripheral surface or the lower surface; the light emitted by the respective optical signal emitting unit is guided into the guide light plate to form an operation zone;

the respective light sensitive unit contacts or near the peripheral surface or the lower surface; when an object is used to conduct touch operation in the operation zone to contact the upper surface, the guide light plate is vibrated to change the stability of the signal carried by the light with respect to the touch point and the respective light sensitive unit on the path of the light outputs unstable signal to allow the optical signal processor to obtain the vibration signals.

Further benefits and advantages of the present invention will become apparent after a careful reading of the detailed description with appropriate reference to the accompanying drawings.

### BRIEF DESCRIPTION OF THE DRAWINGS

FIG. 1 is a top view of the first embodiment of a light vibration touch apparatus in accordance with the present invention illustrating an object touching the touch apparatus;

FIG. 2 is a side view of the first embodiment of a light vibration touch apparatus shown in FIG. 1 illustrating light propagating in the touch apparatus;

FIG. 3 is a graph illustrating vibration signals in a period;

FIG. 4 is a side view of the second embodiment of a light vibration touch apparatus in accordance with the present invention illustrating light propagating in the touch apparatus;

FIG. 5 is a top view of the third embodiment of a light vibration touch apparatus in accordance with the present invention;

FIG. 6 is a side view of the third embodiment of a light vibration touch apparatus shown in FIG. 5 illustrating light propagating in the touch apparatus.

### DETAILED DESCRIPTION OF THE INVENTION

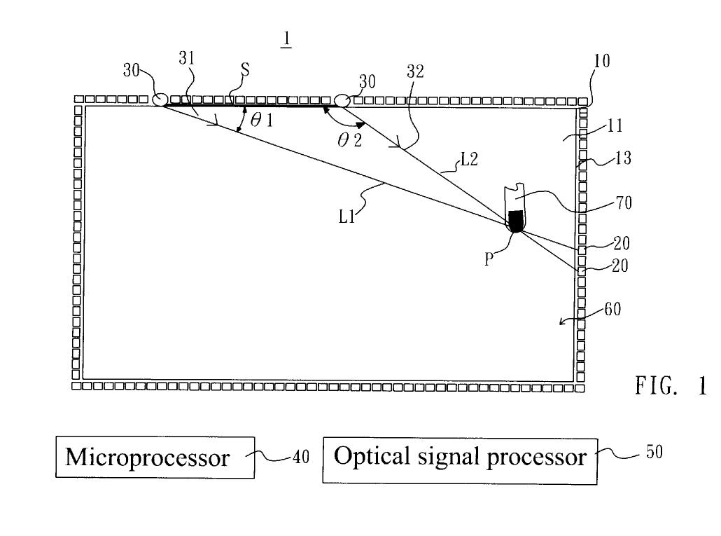

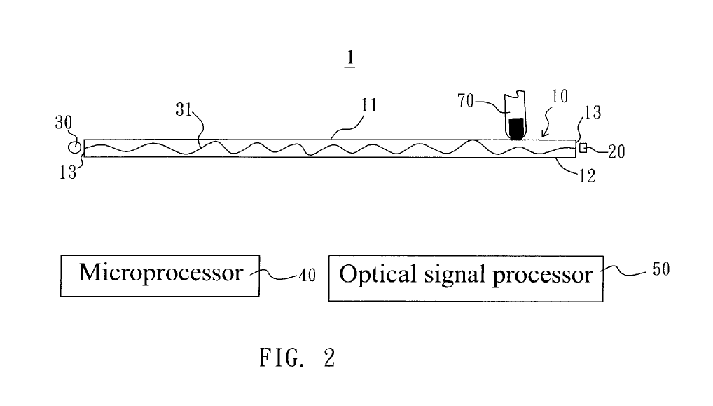

Referring to FIGS. 1 and 2, the first embodiment of a light vibration touch apparatus 1 according to the present invention comprises a guide light plate 10, a plurality of light sensitive units 20, at least two optical signal emitting units 30, a microprocessor 40, and an optical signal processor 50.

The guide light plate 10 is rectangular shape with an upper surface 11, a lower surface 12, and a peripheral surface 13 formed by lateral edges of the guide light plate 10. The guide light plate 10 is a bendable or unbendable plate made of guiding light material such as acrylic, resin or glass.

The light sensitive units 20 can be photodiodes or any light sensitive components. The light sensitive units 20 contact or are disposed near the peripheral surface 13 of the guide light plate 10 to sense lights 31, 32 which are projected by the optical emitting units 30 into the guide light plate 10.

The optical signal emitting units 30 electrically connect with the microprocessor 40; the optical signal emitting units 30 are disposed outside the peripheral surface 13 of the guide light plate 10; the lights 31, 32 projected by the optical signal emitting units 30 carry signals and are guided into the guide light plate 10 to form an operation zone 60. The light sensitive units 20 and the at least two optical signal emitting units 30 surround the operation zone 60. The optical signal emitting units 30 can be LED signal emitting units or LASER signal emitting units.

The optical signal processor 50 is electrically connected to the light sensitive units 20 and the microprocessor 40 respectively. The optical signal processor 50 senses and treats signals output from the light sensitive units 20 to obtain vibration signals and transmit the vibration signals to the microprocessor 40.

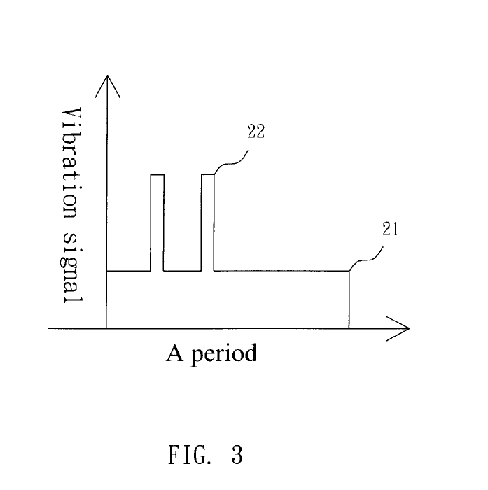

When there is no object 70 touching the upper surface 11 of the guide light plate 10, the optical signal processor 50 receives a non-vibration signal 21 as shown in FIG. 3; when the object 70 conducts a touch operation in the operation zone 60 to contact the upper surface 11 of the guide light plate 10 to generate a touch point P on the upper surface 11, the guide light plate 10 is vibrated and the lights 31. 32. which are corresponding to the touch point P, are changed; that is, when the two lights 31, 32 pass through the touch point P or pass by right underneath the touch point P. the stabilities of the signals carried by the two lights 31, 32 are changed, and the light sensitive units 20 on the paths of the two lights 31, 32 output unstable signals to allow the optical signal processor 50 to receive vibration signals 22 as shown in FIG. 3. Therefore, position information of the touch point P can be obtained and a corresponding touch signal can be output by the microprocessor 40 based the vibration signals in a period being detected sequentially by the microprocessor 40 and in accordance with timings of at least two of the vibration signals 22 appearing in the period as shown in FIG. 3.

As it is shown in FIGS. 1 and 3, the two optical signal emitting units 30 respectively project corresponding lights 31, 32 sequentially to touch the touch point P. The two light sensitive units 20 on the paths of the lights 31, 32 (lines L1 and L2) sense the lights 31, 32 respectively and output unstable signals to allow the optical signal processing unit 50 to obtain two vibration signals 22. Under the circumstances, positions of the two sensitive units 20 can be obtained according to the timings of the two vibration signals appearing in the period. Hence, an angle θ1 between a connecting line S of the two optical signal emitting units 30 and the line L1 and an angle 02 between the connecting line S and the line L2 can be obtained accordingly.

It can be seen in FIG. 1 that the coordinates of the touch point P are figured out with values of the connecting line S, and the angles θ1, θ2 and the trigonometric formulas.

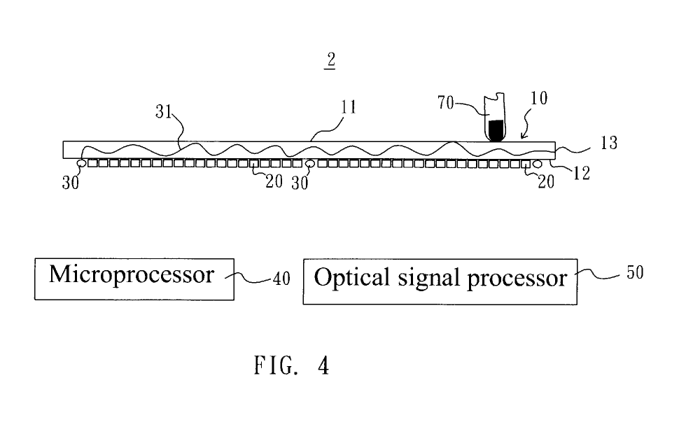

Referring to FIG. 4, the second embodiment of a light vibration touch apparatus 2 according to the present invention comprises a guide light plate 10, a plurality of light sensitive units 20, at least two optical signal emitting units 30, a microprocessor 40, and an optical signal processor 50.

The second embodiment of the light vibration touch apparatus 2 according to the president invention provides a structure almost the same as the preceding first embodiment except the light sensitive units 20 and the optical signal emitting units 30 being disposed under the lower surface 12 of the guide light plate 10. Therefore, the operation, function and calculation related to the microprocessor 40 detecting the vibration signals output by the optical signal processing unit sequentially in a period, obtaining the position information of the touch point based on timings of at least two of the vibration signals appearing in the same period, and outputting the corresponding touch signal are the same as the first embodiment does, and no further details will be repeated here.

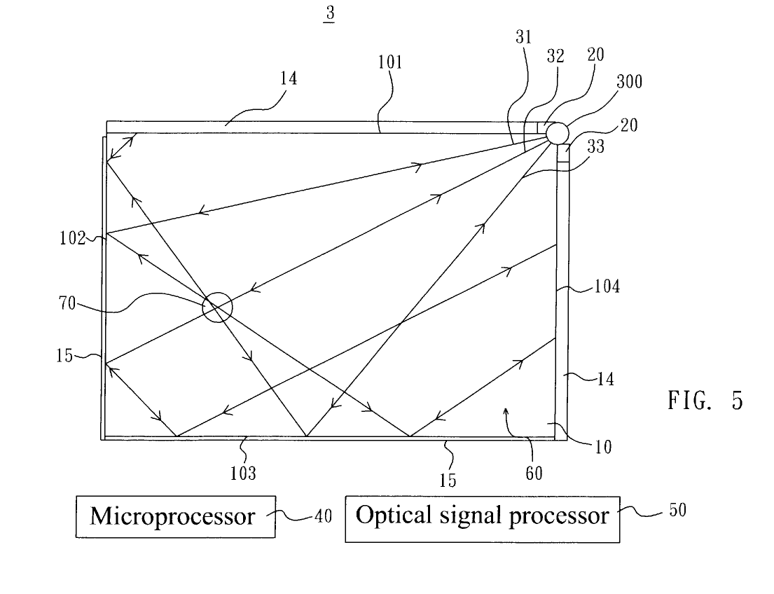

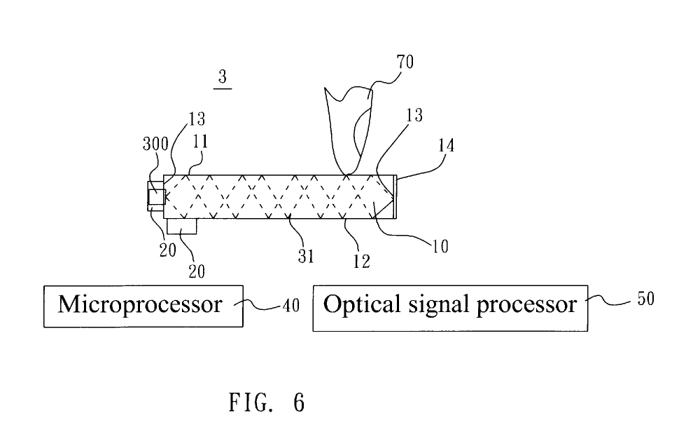

Referring to FIGS. 5 and 6, the third embodiment of a light vibration touch apparatus 3 according to the present invention comprises a guide light plate 10, at least a light sensitive unit 20, an optical signal emitting units 300, a microprocessor 40, an optical signal processor 50, and at least a retro reflector 14. The guide light plate 10 has four sides 101, 102, 103, 104.

Although the optical signal emitting unit 300 being disposed at a corner 100 of the guide light plate 10 to emit a light scanning the entire operation zone 60, the two light sensitive units 20 being close to the optical signal emitting unit 300 respectively to be disposed to contact or be near at least one of the lower surface 12 and the peripheral surface 13 of the guide light plate 10, and two retro reflectors 14, which are strip-shaped, having an end thereof close to the light sensitive units 13 and contacting the guide light plate 10 respectively to correspond to the peripheral surface 13 at the two sides 101, 104 are different from the first embodiment, the mutual connections between the light sensitive units 20, the optical signal emitting unit 300, the microprocessor 40 and the optical signal processor 50, and the functions thereof are the same as the first embodiment and no further details will not be repeated as well.

The optical signal emitting unit 300 is capable of including a flipped mirror or devices such as micro-electromechanical system (MEMS) and micro-opto-electromechanical system (MOEMS) to allow the light beam to scan the operation zone.

The present embodiment can be provided with two reflection film strips 15 being glued on the peripheral surface 13 of the guide light plate 10 at the sides 102, 103 which the retro reflectors do not contact with to enhance reflection effect during the light touching the peripheral surface 13.

The present embodiment can be provided with only a retro reflector 14 to contact the peripheral surface 13 at one of the two sides 101, 104, or the retro reflector 14 is disposed to be opposite to the light guide unit 20, for instance, to contact the peripheral side 13 of the guide light plate 10 corresponding to side 102 or side 103; Alternatively, three reflective film strips 15 are glued to the peripheral surface 13 of the guide light plate 10 at the sides without contacting the retro reflector 14 as well to enhance the reflection effect during the light beam touching the peripheral surface 13.

Lights 31, 32, 33, which are projected by the optical signal emitting unit 300 of the present embodiment, carry signals and are guided into the guide light plate 10 via the peripheral surface 13 respectively to scan the entire operation zone 60. When the lights touch the peripheral surface 13 at the sides 102, 103, part of the lights are reflected into the guide light plate 10; the lights 31, 32, 33, which hit the retro reflector 14 respectively, are retro reflected to the optical signal emitting unit 300 via the original paths. Based on a property of light spreading in the process of propagation, the lights 31, 32, 33 hit the light sensitive units 20 near the optical signal emitting unit 300 as well.

When no object 70 touches the upper surface 11 of the guide light plate 10, the optical signal processor 50 receives a non-vibration signal; when the object 70 conducts touch operation in the operation zone 60 to contact a touch point on the upper surface 11 of the guide light plate 10, the guide light plate 10 is vibrated to change stabilities of the signals carried by the lights 31, 32, 33 corresponding to the touch point P, and the light sensitive units 20 output unstable signals to allow the optical signal processing unit 50 to obtain vibration signals.

Taiwan Patent Application Publication No. 201342161 entitled “LASER SCANNING INPUT DEVICE”, which was filed by the present applicant on Apr. 13, 2012, discloses coordinates calculation technique as a reference of the present embodiment with which the microprocessor 40 detects the vibration signals sequentially output by the optical signal processor 50 in a period, then obtains the position information of the touch point according to timings of at least two vibration signals appearing in the period, and outputs a corresponding touch signal.

It can be conducted with a test to record information related to the touch point of the object contacting the upper surface of the guide light plate and at least two timings of the vibration signals output by the optical signal processor in a period, and then the microprocessor is employed to obtain the position information of the touch point on the upper surface of the guide light plate based on the recorded information and according to the at least two timings of the vibration signals output by the optical signal processing unit in a period.

The characteristic of the present invention is in that when the guide light plate vibrates caused by being touched, the stabilities of the signals carried by the respective lights corresponding to the touch point are changed, and the light sensitive units on the path of the respective lights corresponding to the touch point output unstable signals to allow the optical signal processing unit to obtain vibration signals, that is, the vibration of the guide light plate resulting from being touched is utilized to influence the stabilities of the signals carried by the lights, the optical signal processor outputs vibration signals corresponding to the touch point, and the microprocessor detects the vibration signals sequentially output by the optical signal processor in a period and outputs a touch signal corresponding to the position information of said touch point obtained in accordance with the timings of at least two vibration signals appearing in said period.

It is appreciated that the lights emitted by the optical signal emitting units according to the present invention is not necessary to project into the guide light plate with a specific incident angle in order to conduct the internal total reflection such that inconvenience resulting from adjusting the incident angle can be avoided. Besides, even if the touch point has very small area such as the tip of a toothpick, the vibration generated at the time of the guide light plate being touched can still influence the stability of the optical signal for obtaining the position information of the touch point without frustrating the internal total reflection in the guide light plate so as to promote practical functions of the touch apparatus.

Although the invention has been described in relation to its preferred embodiments, it is to be understood that many other possible modifications and variations can be made without departing from the spirit and scope of the invention as hereinafter claimed.

What is claimed is:

1. A light vibration touch apparatus, comprising:
a guide light plate;
a microprocessor;
at least an optical signal emitting unit electrically connecting with said microprocessor emitting a light respectively;
at least a light sensitive unit sensing said light emitted by said optical signal emitting unit;
an optical signal processor electrically connecting with said microprocessor and said light sensitive unit to detect and process a signal output by said light sensitive unit to obtain a vibration signal and transmit said vibration signal to said microprocessor;
wherein said light emitted by said optical signal emitting unit carries a signal; vibration caused by the guide light plate being touched influencing stability of said signal is utilized; the respective optical signal processing unit outputs a vibration signal corresponding to a touch point; said microprocessor detects the respective vibration signal sequentially output by the respective optical signal processor in a period to obtain position information related to said touch point in accordance with timings of at least two of said vibration signals respectively appearing in said period and output a corresponding touch signal.

2. The light vibration touch apparatus as defined in claim 1, wherein said guide light plate has an upper surface, a lower surface and a peripheral surface; the peripheral surface is formed by lateral edges of said guide light plate; the respective optical signal emitting unit contacts or is disposed near said peripheral surface or said lower surface; the light emitted by the respective optical signal emitting unit is guided into said guide light plate to form an operation zone; the respective light sensitive unit contacts or near said peripheral surface or said lower surface; when an object conducts touch operation in the operation zone to touch said touch point, said guide light plate is vibrated to change the stability of said signal carried by the light with respect to said touch point and the respective light sensitive unit on the path of the light outputs unstable signal to allow said optical signal processor to obtain said vibration signal.

3. The light vibration touch apparatus as defined in claim 2, wherein there are a plurality of said light sensitive units and at least two of said optical signal emitting units.

4. The light vibration touch apparatus as defined in claim 2, wherein said guide light plate is rectangular-shaped with four sides; said optical signal emitting unit is disposed at outer side of a corner of said guide light plate; said light sensitive unit is close to said optical signal emitting unit; the peripheral surface at two sides of said light guide plate contacts two retro reflectors and an end of the respective retro reflector is near said light sensitive unit.

5. The light vibration touch apparatus as defined in claim 4, wherein the peripheral surface at the two other sides of the guide light plate without contacting said two retro reflectors is glued two reflective films respectively to enhance reflection effect at the time of the light hitting said peripheral surface at the two other sides of the guide light plate.

6. The light vibration touch apparatus as defined in claim 2, wherein said guide light plate is rectangular-shaped with four sides; said optical signal emitting unit is disposed at an outer side of a corner of said guide light plate;
said light sensitive unit is close to said optical signal emitting unit; the peripheral surface at one side of said light guide plate contacts a retro reflector.

7. The light vibration touch apparatus as defined in claim 6, wherein the peripheral surface at three other sides of the guide light plate without contacting said retro reflector is glued three reflective films respectively to enhance reflection effect at the time of the light hitting said peripheral surface at the three other sides of the guide light plate.

8. The light vibration touch apparatus as defined in claim 1, wherein said guide light plate is made of guide light material in a form of bendable or unbendable plate.

9. The light vibration touch apparatus as defined in claim 8, wherein the respective light sensitive unit is photodiodes; the respective optical signal emitting unit is LED signal emitting unit or LASER signal emitting unit.

10. The light vibration touch apparatus as defined in claim 2, wherein said guide light plate is made of guide light material in a form of bendable or unbendable plate.

11. The light vibration touch apparatus as defined in claim 10, wherein the respective light sensitive unit is photodiodes; the respective optical signal emitting unit is LED signal emitting unit or LASER signal emitting unit.

12. The light vibration touch apparatus as defined in claim 3, wherein said guide light plate is made of guide light material in a form of bendable or unbendable plate.

13. The light vibration touch apparatus as defined in claim 12, wherein the respective light sensitive unit is photodiodes; the respective optical signal emitting unit is LED signal emitting unit or LASER signal emitting unit.

14. The light vibration touch apparatus as defined in claim 4, wherein said guide light plate is made of guide light material in a form of bendable or unbendable plate.

15. The light vibration touch apparatus as defined in claim 14, wherein the respective light sensitive unit is photodiodes; the respective optical signal emitting unit is LED signal emitting unit or LASER signal emitting unit.

16. The light vibration touch apparatus as defined in claim 5, wherein said guide light plate is made of guide light material in a form of bendable or unbendable plate.

17. The light vibration touch apparatus as defined in claim 16, wherein the respective light sensitive unit is photodiodes; the respective optical signal emitting unit is LED signal emitting unit or LASER signal emitting unit.

18. The light vibration touch apparatus as defined in claim 6, wherein said guide light plate is made of guide light material in a form of bendable or unbendable plate.

19. The light vibration touch apparatus as defined in claim 18, wherein the respective light sensitive unit is photodiodes; the respective optical signal emitting unit is LED signal emitting unit or LASER signal emitting unit.

20. The light vibration touch apparatus as defined in claim 7, wherein said guide light plate is made of guide light material in a form of bendable or unbendable plate.
